(19) United States
(12) Patent Application Publication
(10) Pub. No.: US 2026/0107181 A1
(43) Pub. Date: Apr. 16, 2026

(54) FINER GRANULARITY TRIGGER FRAME SIGNALING

(71) Applicant: Cisco Technology, Inc., San Jose, CA (US)

(72) Inventors: Binita Gupta, San Diego, CA (US); Brian D. Hart, Sunnyvale, CA (US); Malcolm M. Smith, Richardson, TX (US)

(21) Appl. No.: 19/337,113

(22) Filed: Sep. 23, 2025

Related U.S. Application Data
(60) Provisional application No. 63/706,956, filed on Oct. 14, 2024.

(51) Int. Cl. H04W 28/02; H04W 72/0446; H04W 72/21

(52) U.S. Cl. CPC H04W 28/0263; H04W 72/0446; H04W 72/21

(57) ABSTRACT

A method performed by an access point comprises: transmitting, to a station, an enhanced trigger frame to trigger the station to transmit traffic, wherein the enhanced trigger frame includes: a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and a parameter field encoded with particular parameters for the preferred traffic category identifier, the preferred traffic identifier, the preferred traffic stream identifier, or the preferred stream classification service identifier to which the station is to respond with the traffic mapped to the particular parameters.

### CROSS-REFERENCE TO RELATED APPLICATION

This application claims priority to U.S. Provisional Application No. 63/706,956, filed Oct. 14, 2024, the contents of which are incorporated herein by reference.

### TECHNICAL FIELD

The present disclosure relates to network equipment and services.

### BACKGROUND

Networking architectures have grown increasingly complex in communications environments, particularly wireless networking environments. For wireless local area networks, Institute of Electrical and Electronics Engineers (IEEE) 802.11 specifications provide that an Access Point (AP) can send uplink (UL) triggers to wireless devices (also referred to as stations or STAs). Current IEEE 802.11 UL triggers specify a preferred access category (AC) in a trigger frame that indicates the lowest AC for Medium Access Control (MAC) Protocol Data Units (MPDUs) that are recommended to be sent by a STA in response to a trigger frame.

### BRIEF DESCRIPTION OF THE DRAWINGS

FIG. 1 is a schematic diagram illustrating a trigger dependent user information (User Info) subfield format for a Basic Trigger Frame, according to an example embodiment.

FIG. 2 is a block diagram of a system that may be implemented to facilitate finer granularity trigger frame signaling for a wireless local area network (WLAN), according to an example embodiment.

FIG. 3A is a schematic diagram illustrating an Extremely High Throughput (EHT) variant User Info field format signal enhancement to the Basic Trigger Frame that provides Traffic Category Identifier (TCID) based finer granularity trigger frame signaling, according to an example embodiment.

FIG. 3B is a schematic diagram illustrating a High Efficiency (HE) variant User Info field format signal enhancement to the Basic Trigger Frame that provides TCID based finer granularity trigger frame signaling, according to an example embodiment.

FIG. 3C is a schematic diagram illustrating a trigger dependent user information subfield format signal enhancement to the Basic Trigger signal that provides TCID based finer granularity trigger frame signaling, according to an example embodiment.

FIG. 4A is a schematic diagram illustrating a trigger dependent user information subfield format signal enhancement to the Basic Trigger signal that provides TCID/Traffic Identifier (TID)/Traffic Stream Identifier (TSID)/Stream Classification Service Identifier (SCSID) (TCID/TID/TSID/SCSID) based finer granularity trigger frame signaling, according to various example embodiment.

FIG. 4B is a schematic diagram illustrating an EHT variant User Info field format signal enhancement to the Basic Trigger Frame that provides TCID/TID/TSID/SCSID based finer granularity trigger frame signaling, according to an example embodiment.

FIG. 4C is an illustration of association identifier (AID) 12-bit (AID12) subfield encoding, according to an example embodiment.

FIG. 5 shows an enhanced trigger frame having multiple user information fields used for signaling finer granularity triggering, according to an embodiment described above.

FIG. 6 shows an enhanced trigger frame having multiple user information fields used for signaling finer granularity triggering, according to an example embodiment.

FIG. 7 is a flowchart of a method performed by an access point (AP) to signal to a station (STA) finer granularity triggering, according to an example embodiment.

FIG. 8 is a flowchart of a method performed by an AP for finer granularity triggering of a STA, according to an example embodiment.

FIG. 9 illustrates a hardware block diagram of a computing device configured to perform functions associated with operations discussed in connection with embodiments herein.

### DETAILED DESCRIPTION

### Overview

Embodiments herein provide for enhancing the Basic Trigger Frame to support more granular uplink (UL) triggering that can be based on Traffic Category Identifier (TCID) representing Traffic Identifier (TID) values 0 to 7, TID representing TID values 0 to 15, Traffic Stream Identifier (TSID) representing TID values 8 to 15, or Stream Classification Service Identifier (SCSID). More granular triggering refers to UL triggering for stations which is more granular than the current 802.11 baseline defined signaling based on preferred Access Category (AC) based triggering. Embodiments herein may provide various signaling formats for TCID, TID, TSID, or SCSID based triggering to enable an IEEE 802.11/wireless local area network (WLAN) access point (AP) to trigger wireless devices, also referred to as clients or stations (STAs), for specific flows (e.g., mapped to TCID, TID, TSID, or SCSID). This may ensure that an AP triggers the right set of flows in UL triggers for which resources are requested and authorized using SCS+QC (Quality of Service (QoS) Characteristic element) in order for STAs to prioritize sending traffic for those flows in response to trigger frames, for efficient resource allocation by the AP.

In an embodiment, a method performed by an AP comprises: transmitting, to a station, an enhanced trigger frame to trigger the station to transmit traffic, wherein the enhanced trigger frame includes: a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and a parameter field encoded with particular parameters for the preferred traffic category identifier, the preferred traffic identifier, the preferred traffic stream identifier, or the preferred stream classification service identifier to which the station is to respond with the traffic mapped to the particular parameters.

### Example Embodiments

In a wireless local area network (WLAN) or Wi-Fi® network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

Current WLAN/Wi-Fi standards, such as Institute of Electrical and Electronics Engineers (IEEE) 802.11 provide that when an AP sends uplink UL triggers to STAs, it specifies a Preferred AC (Access Category, sometimes referred to as Access Class) value in a trigger frame. The preferred AC indicates the lowest AC for Medium Access Control (MAC) Protocol Data Units (MPDUs) that are recommended to be sent in response to the trigger frame.

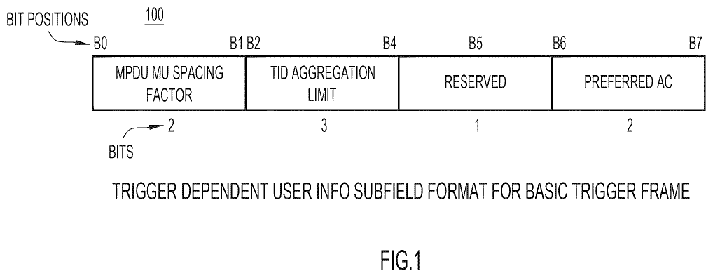

FIG. 1 is a schematic diagram illustrating an example trigger dependent user information subfield format 100 for a Basic Trigger Frame. The Basic Trigger Frame includes fields for an MPDU MU spacing factor, a TID aggregation limit, a reserved bit, and a preferred AC.

With SCS+QC added in 802.11be (11be), a STA specifies QoS requirements for one or more specific SCS flows and requests an AP to allocate UL resources for those SCS flows. Then, in an ideal scenario, the AP would like to trigger the STA only for those SCS flows, since UL resources are reserved for those SCS flows. However, such operation is not possible with the current trigger frame format as provided in 802.11 standards.

Additionally, in 802.11bn (11bn), some potential enhancements are being considered for using more TIDs besides TCIDs (i.e., TID values of 0 to 7), with further enhancements to using TSID values (i.e., TID values in a range 8 to 15). This can enable mapping different SCS flows to different TID values (in a range 0 to 15). Hence, in those cases where SCS flows get mapped to different TSIDs or TCIDs, then an AP can also send a trigger based on TSID/TCID to trigger a particular SCS flow.

Embodiments herein provide an enhancement to the trigger frame signaling format to enable triggering STAs based on TCIDs/TIDs/TSIDs/SCSIDs.

From the perspective of different use cases, such as Augmented Reality (AR)/Virtual Reality (VR)/Mixed Reality (MR) use cases (collectively referred to as XR use cases) and Industrial IOT (IIOT) use cases, such use cases typically rely upon triggered uplink access (TUA) today to achieve low latency (e.g., using SCS+QC). However, TUA specifically may be limited by AC based triggering (especially min/max Service Interval (SI)) that can result in wasteful triggering based on the aggregate requirement sent in the SCS+QC (e.g., tiny fast UL pose frames and slow speed high throughput voice in the same trigger).

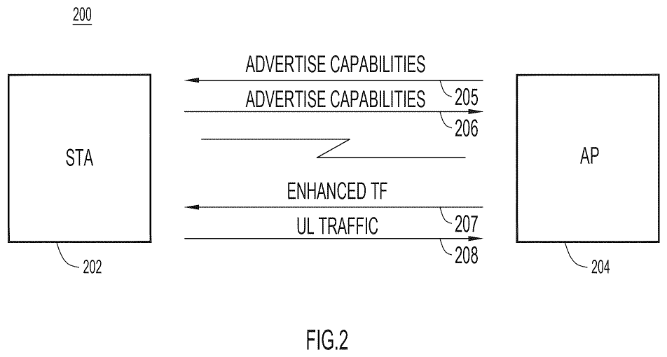

Referring to FIG. 2, FIG. 2 is a block diagram of a system 200 that may be provided to facilitate finer granularity trigger frame signaling (also referred to as finer grain trigger frame signaling and fine grain trigger frame signaling) for a WLAN, according to an example embodiment. In at least one embodiment, system 200 may include a WLAN (not specifically shown) that includes at least one STA 202 and at least one AP 204 (e.g., a wireless AP). In the example, AP 204 transmits to STA 202 signaling frame 205 that advertises finer granularity triggering (FGT) capabilities supported by the AP, e.g., in Beacon, Probe Response, or (Re)association (i.e., Association or Reassociation) Response frames. Similarly, the STA signals its capability support for finer granularity signaling to the AP in signaling frame 206, e.g., in an Association request or a Reassociation request or another management frame. The AP 204 sends an enhanced trigger frame (TF) 207 to STA 202 indicating the finer granularity triggering, to trigger the STA to respond with UL traffic. STA 202 transmits to AP 204 UL traffic 208 triggered by the enhanced trigger frame.

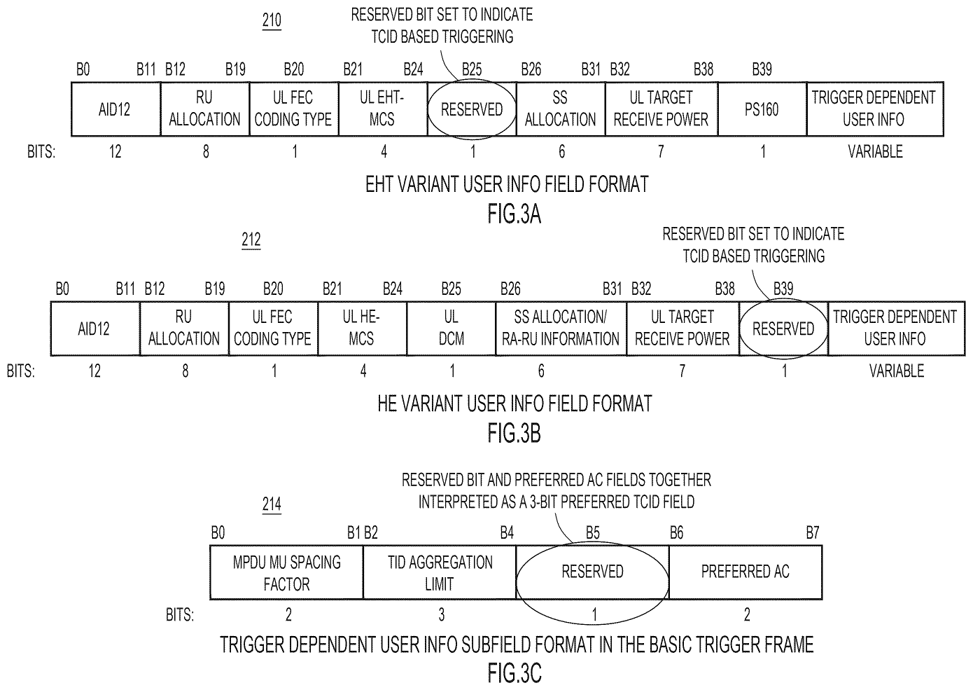

Various approaches are provided through embodiments herein for various signaling enhancements, as discussed with reference to FIGS. 3A, 3B, 3C, 4A, 4B, 4C, 5, and 6, which are schematic diagrams illustrating signaling enhancements that can be provided in accordance with embodiments herein to facilitate finer granularity trigger frame signaling.

### Approach A: Enhanced Trigger Frame to Indicate TCID Based Triggering

In at least one embodiment, to support TCID based triggering (for TID values 0 to 7), one signaling approach may include using one reserved bit in the Extremely High Throughput (EHT) variant User Info field 210 to signal TCID based triggering, as shown in FIG. 3A, or using the High Efficiency (HE) variant User Info field 212 to signal TCID based triggering, as shown in FIG. 3B. As shown in FIG. 3A, the EHT variant User Info field 210 includes a set of smaller fields (or subfields) encoded to include values for a 12-bit association identifier (AID) (also referred to as AID12) of a STA, a resource unit (RU) allocation, a UL forward error correction (FEC) coding type, a UL EHT-modulation and coding scheme (MCS) (EHT-MCS), a previously reserved field set to indicate TCID based triggering, a synchronization signal (SS) allocation, a UL target receive power, a PS160, and trigger dependent user info.

Similarly, as shown in FIG. 3B, the HE variant User Info field 212 includes a set of smaller fields (or subfields) encoded to include values for an AID of a STA, an RU allocation, a UL FEC coding type, a UL HE-MCS, a UL dispersion code multiplexing (DCM), an SS allocation/RA-RU information, a UL target receive power, a previously reserved field set to indicate TCID based triggering, and trigger dependent user info.

When the Reserved bit is set to 1 to indicate TCID based triggering as shown in FIGS. 3A and 3B, the fields in the Trigger Dependent User Info subfield 214 can be interpreted as follows: the Reserved bit and Preferred AC fields together can be interpreted as a new 3-bit Preferred TCID field as shown in FIG. 3C.

The Preferred TCID field can be used to indicate the lowest TID value that is recommended by the AP for MPDUs/A-MPDUs sent in response to the trigger frame. A STA is recommended to respond with MPDUs/A-MPDUs of a preferred TCID or other higher TIDs (up to maximum TID of 7). If a TSID space (from values 8 to 15) is also used for flows, then MPDUs/Aggregate MPDUs (A-MPDUs) of all the TSIDs that map to the AC corresponding to the Preferred TCID or higher ACs are also allowed/recommended to be sent in response to the trigger frame. For example, if TSID values 8 to 9 are allowed, the Preferred TCID is value 6 (that corresponds to AC Voice/AC_VO) and a flow that maps to TSID 9 has UP (User Priority) value 7 that maps to AC_VO, and another flow that maps to TSID 8 has UP (User Priority) value 5 that maps to AC_VI (AC Video). Then when the STA is responding to the enhanced trigger frame with Preferred TCID of 6, the MPDUs/A-MPDUs of the flow that maps to TSID 9 (which maps to AC_VO) can be sent in the UL, but not of the flow that maps to TSID 8 (because this maps to AC_VI, which is lower than preferred TCID indicated).

When additional TIDs from lower ACs (AC_BK/AC background or AC_BE/AC best effort) are allowed to be mapped to higher ACs (AC_VI or AC_VO) (per additional TID mapping rules), then flows of higher ACs can be carried in lower TIDs that traditionally map to lowers ACs (AC_BK or AC_BE). For example, if TID 3 (from AC_BE) is mapped to AC_VO, then a flow with a UP that maps to AC_VO can be carried in TID 3. Similarly, if TID 2 (from AC_BK) is mapped to AC_VI, then a flow with a UP that maps to AC_VI can be carried in TID 2. In this case, when an enhanced trigger frame indicates a Preferred TCID field as described above, then the STA can also respond with MPDUs/A-MPDUs of the flow(s) that map to lower TIDs but which are mapped to the AC corresponding to Preferred TID or higher ACs, per additional TID mapping rules.

In an embodiment, the Reserved bit (B5) in the Trigger Dependent User info field of the Basic Trigger frame is set to 1 always for the TCID based triggering. The three bits (B5, B6, and B7) indicate the preferred TCID values which could be TID 4, 5, 6 or 7. In this case, no separate bit is used to indicate that the Triggering is per Preferred TID. A STA would interpret, from bit B5being set to 1, that the TCID based triggering is indicated.

The TCID based triggering described above is a specific form of what is more broadly referred to as finer granularity triggering, described below.

### Approach B: Enhanced Trigger Frame to Indicate TCID/TID/TSID/SCSID Based Triggering

In one case, the enhancements proposed for finer granularity triggering in the Approach A embodiments above and in the Approach B embodiments below can be applied to any other trigger frame that is used for UL triggering for STAs, besides the Basic Trigger frame.

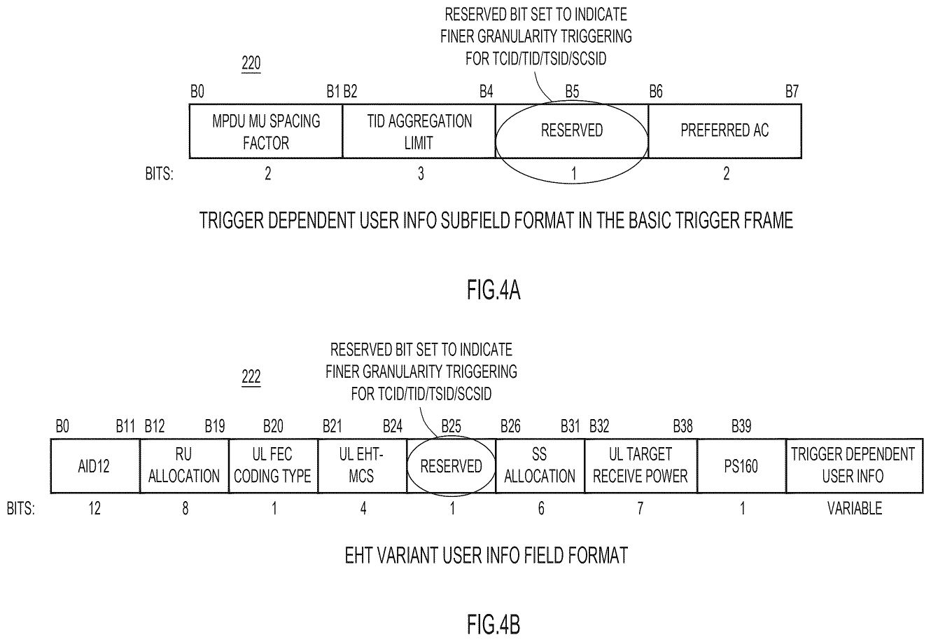

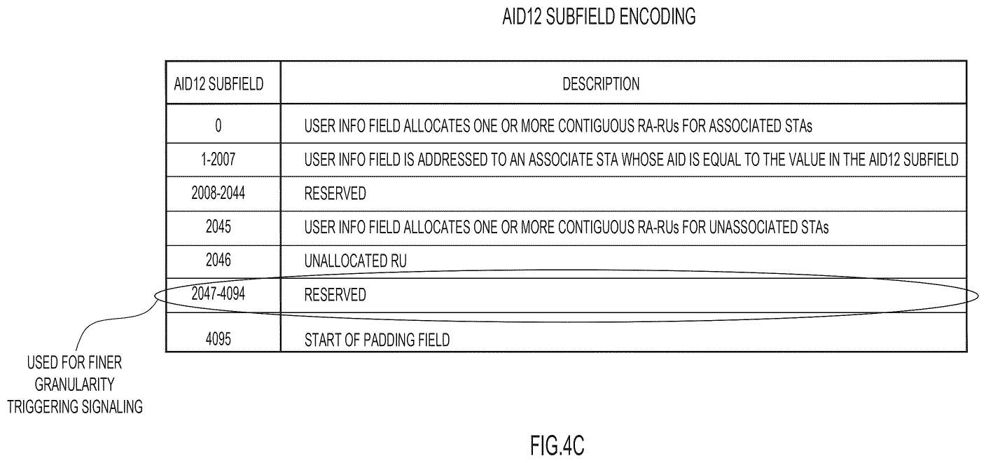

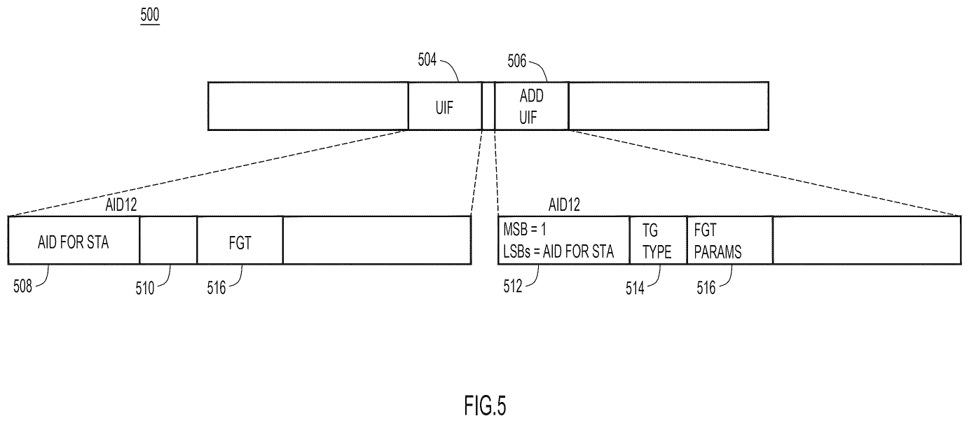

In another embodiment, another signaling approach may involve using a Reserved bit in the Trigger Dependent User Info subfield 220 that can be used to indicate finer granularity triggering or a similar indication, as shown in FIG. 4A. Finer granularity triggering refers to an AP providing/signaling to a STA an enhanced trigger frame for finer granularity triggering that specifies to the STA triggering of UL traffic at a lower granularity level of one or more of a TCID (TID values 0 to 7), a TID (TID values 0 to 15), a TSID (TID values 8 to 15), and/or a SCSID (rather than at a higher granularity level of an AC), and to which the STA is to respond to the enhanced trigger frame by transmitting traffic flow(s) that are mapped to the indicated TCID, TID, TSID or higher TID values, and/or the SCSID. That is, TCID/TID/TSID/SCSID based triggering enables an AP to trigger STAs for specific flows, mapped to the TCID, the TID, the TSID, or the SCSID. In one case, in the enhanced trigger frame the AP can indicate multiple values for TCID, TID, TSID, e.g., using a bitmap field where each bit indicates the presence of a specific TCID, TID, or TSID. In this case, the STA would respond with UL traffic for flows that are mapped to any of those indicated TCID, TID, or TSID values. The AP can also signal multiple SCSIDs in the enhanced trigger frame, and then the STA can respond with UL traffic for flows that are mapped to any of the indicated SCSIDs.

In all the cases of finer granularity triggering defined based on TCID/TID/TSID, if additional TID mapping rules are used where additional TIDs from lower ACs (AC_BK/AC background or AC_BE/AC best effort) are allowed to be mapped to higher ACs (AC_VI or AC_VO), then in response to the enhanced trigger frame, the STA can also respond with MPDUs/A-MPDUs of the flow(s) that map to lower TID values (from AC_BE or AC_BK) but which are mapped to the AC(s) corresponding to indicated TCID/TID/TSID or higher ACs per additional TID mapping rules.

Alternatively, a Reserved bit in the EHT variant User Info field 222 (or the HE variant user info field) can be used to indicate finer granularity triggering or similar, as shown in FIG. 4B.

To provide finer granularity triggering information to a STA in at least one embodiment, the Basic trigger frame can be enhanced to include an additional/special User Info field (a new or special User Info field for finer granularity triggering) targeted for a particular STA, where the AID12 field (11 least significant bits (LSBs) of an AID) is set to the AID12 field of the STA with the MSB (most significant bit) set to 1. More than one additional User Info field can be included in the Basic Trigger frame to indicate finer granularity triggering for multiple STAs (based on their AID12 values).

Note, that in current 802.11 specifications, AID values between 1 to 2007 can be assigned to non-AP STAs/non-AP MLDs (non-AP Muli-Link Devices). For these AID values, the MSB bit is set to 0 in the 12-bit AID field. In the additional User Info field that is included and targeted for the STA, the 11 LSB bits of the AID12 subfield are set to the 11 bits of the AID value assigned to the STA and the MSB bit of AID12 field is set to 1.

Note further that per current 802.11 specifications, the trigger frame should not include more than one User Info field with the same value in the AID12 field, unless the value in the AID12 subfield is 0 or greater than 2007.

Embodiments herein align with this baseline rule for the trigger frame behavior since the additional User Info field has a different AID12 value (with MSB set to 1). The range of Association ID (AID) values for the additional User Info field may be from 2048 (0b 100000000001) to 4055 (0b 111111010111). This AID12 range is reserved in the baseline 802.11 specification. Thus, embodiments herein define the use of many of the AID12 values from the reserved range (2047-4094) in the additional User Info field as illustrated with reference to FIG. 4C.

For example, for a User Info field targeted to a STA that has AID=1020 assigned, the AID12 field is set to 1020 (0b 001111111100) in the User Info field. In the additional User Info field included for that STA to indicate finer granularity triggering, the AID12 field=0b 101111111100 (value=3068, which is the STA's 12-bit AID with the MSB flipped to 1). The AP can include this additional User Info field in the Basic Trigger frame after any other User Info fields that have AIDs in the range from 1 to 2007.

The User Info field that contains the AID12 field set to the AID of the STA (typically defined in the AID range 1-2007) includes all the fields as defined for the Basic Trigger frame with a Reserved bit indicating finer granularity triggering as discussed above. When the finer granularity triggering bit is set to 1, the Preferred AC field (+attached Reserved bit) in the Trigger Dependent User Info subfield of this User Info filed can be repurposed to indicate a Triggering Granularity Type field, as discussed in further detail below. Alternatively, the Triggering Granularity Type field can be provided in the additional/special User Info field included for finer granularity triggering after the AID12 field (containing AID12 of the STA with MSB set to 1) as described below.

In the additional/special User Info field, which has the AID12 field set to the 12-bit AID of the STA with the MSB set to 1, the remaining 28 bits after the AID12 field may be used to indicate fine granular triggering information.

In various embodiments, the additional/special User Info field can specify (after the AID12 field):
A Triggering Granularity Type field (if not indicated by repurposing the Preferred AC value in the normal User Info field targeted for the STA, as described above). This field indicates the type of triggering granularity. This field can indicate one of the following triggering granularity types:
   Type 1—List of Access Categories for triggering.
   Type 2—Preferred TCID based triggering.
   Type 3—Preferred TID based triggering.
   Type 4—Preferred TSID based triggering.
   Type 5—Preferred TCID and TSID based triggering.
   Type 6—List of preferred TIDs for triggering.
   Type 7—Preferred one or more SCSIDs for triggering.

Only a few options from the list of types above may be defined for the Triggering Granularity Type field or additional options may be defined. A 2-bit/3-bit/4-bit field can be used to indicate a Triggering Granularity Type.

Based on the Triggering Granularity Type (value), the rest of the bits in the additional User Info field can be interpreted. In the following format, the Triggering Granularity Type field is only included if not specified in the normal User Info field of the STA (by repurposing the Preferred AC field (+attached Reserved bit)).

For a List of Access Categories for triggering type, the additional User Info field can include: (AID12+Triggering Granularity Type+Preferred AC bitmap (4 bits)+Reserved bits).

For this triggering type, bits in the Preferred AC bitmap field represent four ACs. One or more bits corresponding to preferred ACs can be set to 1. A STA is recommended to respond with MPDUs/A-MPDUs of preferred ACs indicated, in response to the trigger frame.

For a Preferred TCID based triggering type, the additional User Info field can include:
(AID12+Triggering Granularity Type+Preferred TCID (3 or 4 bits)+Reserved bits).

The Preferred TCID value can be in the range 0 to 7. For this triggering type, a STA is recommended to respond with MPDUs/A-MPDUs of a Preferred TCID or higher TCIDs in response to the trigger frame. If TSID space is used (TID values 8 to 15), then a STA is also recommended to respond with MPDUs/A-MPDUs of all the TSIDs that map to the AC corresponding to the Preferred TID or higher ACs. If additional TID mapping rules are used (as described above), then the STA can also respond with MPDUs/A-MPDUs of the flow(s) that map to lower TID values (from AC_BE or AC_BK) but which are mapped to the AC(s) corresponding to Preferred TCID or higher TCIDs.

For a Preferred TID based triggering type, the additional User Info field can include:
(AID12+Triggering Granularity Type+Preferred TID (4 bits)+Reserved bits).

The Preferred TID value can be in the range 0 to 15. For this triggering type, a STA is recommended to respond with MPDUs/A-MPDUs of Preferred TID or higher TIDs in response to the trigger frame. If additional TID mapping rules are used (as described above), then the STA can also respond with MPDUs/A-MPDUs of the flow(s) that map to lower TID values (from AC_BE or AC_BK) but which are mapped to the AC(s) corresponding to Preferred TCID or higher TCIDs.

For a Preferred TSID based triggering type, the additional User Info field can include:
(AID12+Triggering Granularity Type+Preferred TSID (3 or 4 bits)+Reserved bits).

The Preferred TSID value can be in the range 8 to 15. For this triggering type, a STA is recommended to respond with MPDUs/A-MPDUs of a Preferred TSID or higher TSIDs in response to the trigger frame. In another embodiment, the STA is recommended to respond with MPDUs/A-MPDUs of the Preferred TSID or other TSIDs that map to same or higher ACs than the AC corresponding to the Preferred TSID.

For a Preferred TCID and TSID based triggering type, the additional User Info field includes:
(AID12+Triggering Granularity Type+Preferred TCID (3 or 4 Bits)+Preferred TSID (3 bits)+Reserved bits).

The Preferred TCID value can be in the range 0 to 7. The Preferred TSID value can be in the range 8 to 15. For this triggering type, a STA is recommended to respond with MPDUs/A-MPDUs of Preferred TCID or higher TCIDs in response to the trigger frame. If additional TID mapping rules are used (as described above), then the STA can also respond with MPDUs/A-MPDUs of the flow(s) that map to lower TID values (from AC_BE or AC_BK) but which are mapped to the AC(s) corresponding to Preferred TCID or higher TCIDs. A STA is recommended to respond with MPDUs/A-MPDUs of the Preferred TSID or other TSIDs that map to same or higher ACs than the AC corresponding to the Preferred TSID. In another embodiment, a STA is recommended to respond with MPDUs/A-MPDUs of preferred TSID or higher TSID values.

For a List of preferred TIDs for triggering type (covering TCIDs and TSIDs), the additional User Info field includes:
(AID12+Triggering Granularity Type+Preferred TID bitmap (16 bits)+Reserved bits).

For this triggering type, bits in the Preferred TID bitmap field represent TIDs from 0 to 15 (covering TCIDs from 0 to 7 and TSIDs from 8 to 15). Bits that correspond to preferred TIDs are set to 1. A STA is recommended to respond with MPDUs/A-MPDUs of preferred TIDs indicated, in response to the trigger frame.

For a preferred one or more SCSIDs for triggering type, the additional User Info field includes:
(AID12+Triggering Granularity Type+Count of SCSID (e.g., 2 bits)+List of Preferred SCSIDs (up to 3 SCSIDs, 8 to 24 bits)+Reserved bits).

For this triggering type, the list of Preferred SCSIDs field specifies a list of one or more preferred SCSID (up to 3 SCSIDs). A STA is recommended to respond with MPDUs/A-MPDUs of preferred SCSIDs indicated, in response to the trigger frame.

FIG. 5 shows an example enhanced trigger frame 500 having multiple User Info fields (UIFs) and used for signaling finer granularity triggering to a STA, according to the embodiments described above. Enhanced trigger frame 500 includes a User Info field 504 and an Additional (Add) User Info field 506 directed to the same STA. User Info field 504 includes an AID field 508 encoded with a 12-bit AID of the STA such that the lower 11-bits of the AID field stores the AID of the STA, and the MSB of the AID field is set to 0. User Info field 504 also includes a finer granularity triggering (FGT) field/flag 510 set to indicate the finer granularity triggering, as described above. Additional User Info field 506 includes an AID field 512 encoded such that the lower significant 11-bits are set to the AID of the STA, but the MSB is set to 1 which indicates that the User Info field is an additional User Info field (or a special User Infor field). Additional User Info field 506 further includes a Trigger Granularity (TG) Type field 514 encoded to indicate a type of triggering granularity as defined above using the Triggering Granularity Type. Additional User Info field 506 also includes an FGT Parameters field 516 that carries particular FGT Parameters or values for the type of triggering granularity indicated by the Triggering Granularity Type field 514, as described above for different values of the Triggering Granularity Type. For example, if the Triggering Granularity Type is set to List of preferred TIDs, then the FGT Parameters field includes a Preferred TID bitmap. In one embodiment, the Triggering Granularity Type field 514 is not included in additional User Info field 506, but instead the Triggering Granularity Type is indicated in User Info field 504 by including a Triggering Granularity Type field in the User Info field.

In another embodiment, the AP could indicate a hybrid of one or more options in the enhanced trigger frame—Preferred ACs, Preferred TCIDs, Preferred TIDs, Preferred TSIDs, Preferred SCSID. A new Triggering Granularity Type can be defined for the hybrid option. An enhanced trigger frame format can be defined that allows the AP to indicate a hybrid of these options. For example, the AP could indicate, in an enhanced trigger frame, triggering for AC_VO Access Category+TID 5+TSID 8+a specific SCSID value. In such a case, the additional User Info field would be formatted to include the corresponding parameters to indicate a hybrid set of options for triggering.

In at least one embodiment, a Reserved AID12 value can be used in the additional User Info field (instead of a STA AID12 value with MSB set to 1), for example, an AID12 value of 2008 or any other reserved value may be used. This new AID12 value can be referred to as a special AID for finer granularity triggering. The additional User Info field with this new AID12 value can include another AID12 value that is set to the AID12 of the STA, for example, immediately following the special AID12 field. The remaining bits in the additional User Info field can be used to indicate the preferred TCID/TID/TSID/SCSID based triggering. In at least one embodiment, such a format could be provided as follows:
AID12 (special AID12 value, 12 bits)+AID12 (STA AID value, 11/12 bits)+Triggering Granularity Type+Preferred TCID/TID/TSID or Preferred SCSID.

Every STA can process this additional User Info field with special AID12 value (e.g., AID12 value=2008) and then look for the STA's AID in that additional User Info field. If a STA's AID is included, the STA parses additional fields in this User Info field to fully interpret the trigger frame.

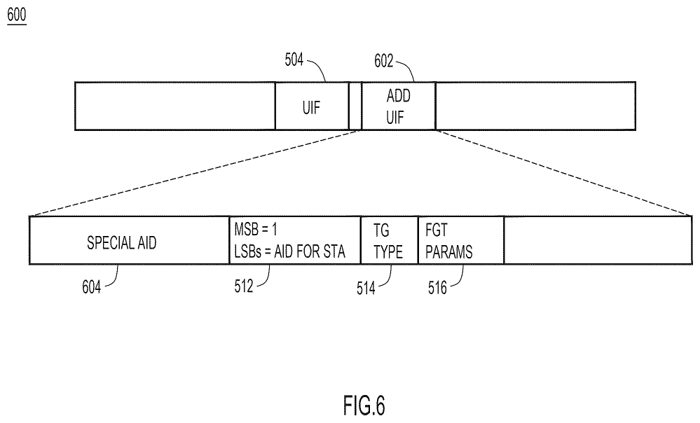

FIG. 6 shows an example enhanced trigger frame 600 that includes the special AID field for finer granularity triggering. In the example, enhanced trigger frame 600 includes User Info field 504 as described in connection with FIG. 5 and an additional User Info field 602. Additional User Info field 602 includes a special AID field 604 encoded with an AID that is not used for any STA, as described above. In addition, additional User Info field 602 includes AID field 512, Triggering Granularity Type field 514, and FGT Parameters field 516, as described above.

### Additional TID Mapping Rules—That are Maps High QoS Flows to Lower TIDs in AC_BE and AC_BK

In some cases, high QoS traffic flows that have User Priority (UP) for Voice or Video can be mapped to lower TIDs value that are mapped to AC_BK or AC_BE in order to separate flows in their own TIDs. For example, when there are multiple video flows, in order to keep these flows on separate TIDs to avoid head-of-line blocking from one flow to the other, one of the video flows may be mapped to a lower TID from AC_BE of AC_BK such as to TID 1, or, 2 or 3. In this case, when an AP sends a finer granularity (i.e., enhanced) trigger frame based on Preferred TCID(s) (for values between 0 to 7), Preferred TID(s) (for values between 0 to 15), or Preferred TSID (for values between 8 to 15), then the high QoS flows that were mapped to lower TIDs should still be allowed to be transmitted by the STA in the UL in response to the finer granularity trigger frame, as long as the UP of that flow maps to the AC(s) that corresponds to the indicated Preferred TID/TCID in the trigger frame or a higher TID/TCID.

When a flow is mapped to TSID space (with values between 8 to 15), the same rule can apply. The STA can respond with flows that are mapped to TSIDs in response to a finer granularity trigger frame (indicating Preferred TCID) as long as the UP of the flow maps to AC(s) that corresponds to the indicated TCID in the trigger frame or a higher TCID.

Note that, typically, the UP for a flow is determined based on the mapping Differentiated Services Code Point (DSCP) bits in the IP header to UP for that flow. In some cases, the UP for a flow can be assigned based on criticality or importance for the flow. Also, note that there is a 1:1 mapping from UP values to TID values (UP0 is TID 0, UP1 is TID1, . . . , UP6 is TID6 and UP7 is TID7).

### Capability Indication for Finer Granularity Triggering

In various embodiments, an AP can advertise that it supports finer granularity triggering in Beacon, Probe Response, and/or (Re)Association Response frames (e.g., in an Ultra High Reliability (UHR) Capabilities element or another element). In at least one embodiment, an AP can indicate what types/levels of triggering granularity it supports as part of its capability indication. In at least one embodiment, a STA can also indicate its support for finer granularity triggering and the types of triggering granularity it supports as part of its capability indication (e.g., in a UHR Capabilities element or another element in a (Re)Association Request frame or another management frame).

An AP can use the triggering granularity type(s) that is/are supported by a STA when triggering that STA. If a STA supports multiple triggering granularity types (as defined above) then an AP can use any of those triggering granularity when triggering that STA (if also supported by the AP).

In another embodiment, the AP and the STA can negotiate a (preferred) triggering granularity type(s) to use as part of (Re)Association Request/Response exchange or via another management frames (request and response) exchange. For example:
The STA can indicate its preference for triggering granularity type(s) in the (Re)Association request frame or another management request frame (e.g., SCS Request frame). In at least one embodiment, the STA can also indicate its most granular triggering type (e.g., TCID based triggering).
The AP can respond with the selected triggering granularity type(s) to use for that STA in the (Re)Association Response frame or another management response frame (e.g., SCS Response frame). In at least one embodiment, the AP can select the triggering granularity type(s) to use from the STA-supported triggering granularity types, potentially taking into consideration preference(s) indicated by the STA and AP's own policy. In at least one embodiment, the AP can also respond with the most granular triggering type selected (e.g., SCSID based Triggering Granularity Type). In at least one embodiment, the AP can use that triggering granularity or any less granularity triggering for the STA. For example, if the SCSID based Triggering Granularity Type is selected, the AP can use the TCID based, TID based, or TSID based Triggering Granularity Types as well, since these are less granular than SCSID based Triggering Granularity Types.

In another embodiment, a STA can indicate its preferred Triggering Granularity Type(s) for an SCS UL flow in an SCS Request frame. The AP can accept the STA request if it aligns with supported capability and policy at the AP. If the AP cannot accept the preferred Triggering Granularity Type(s) from the STA for the SCS flow (e.g., for policy reason(s)), then the AP can reject the SCS request indicating an appropriate failure (e.g., REJECTED_Triggering_granularity_not_accepted).

In another embodiment, a STA can request its preferred Triggering Granularity Type(s) across any SCS flows through an SCS Request frame. Such an SCS request can indicate an SCSID of value 0 or 255, indicating that the SCS request applies across all SCS flows. In at least one embodiment, a new element/sub-element can be added to the SCS Descriptor element to include finer granularity triggering related information.

In another embodiment, an AP can dynamically change the Triggering Granularity Type it will use for a STA, across the supported and/or preferred Triggering Granularity Types indicated by that STA. An AP can achieve this by sending an unsolicited management frame, for example, by sending an unsolicited SCS Response frame with this information.

Accordingly, embodiments herein may provide signaling formats for TCID/TID/TSID/SCSID based triggering to enable an AP to trigger STAs for specific flows (mapped to TCID, TID, TSID, or SCSID). This may ensure that the AP triggers the right set of flows for UL triggers for which resources are requested and authorized using SCS+QC, and that STAs prioritize sending traffic for those flows in response to trigger frames, for efficient resource allocation by the AP.

### Flowcharts

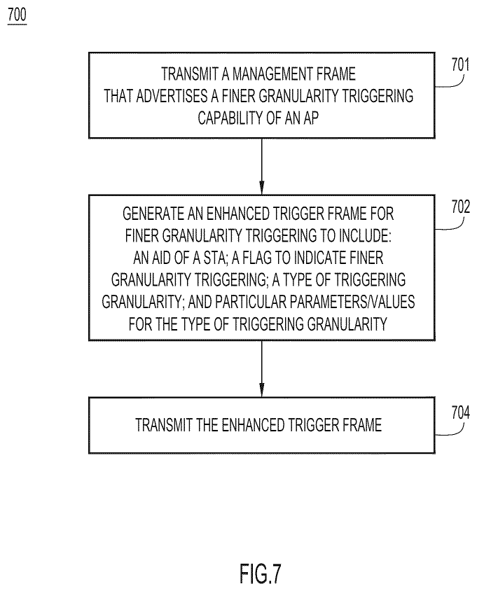

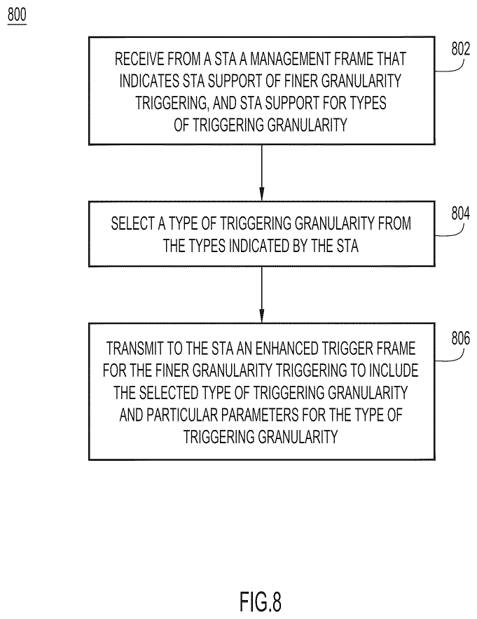

FIG. 7 is a flowchart of an example method 700 performed by an AP to signal to a STA finer granularity triggering, to trigger the STA to transmit traffic.

At 701, the AP transmits a management frame that advertises a finer granularity triggering capability of the AP, i.e., to indicate that the AP supports finer granularity triggering.

At 702, the AP generates an enhanced trigger frame for the finer granularity triggering. The enhanced trigger frame includes a user information field (e.g., referred to above as the User Info field) having a first AID field encoded with an AID of the STA. The enhanced trigger frame includes a finer granularity triggering field (e.g., a flag) indicating finer granularity triggering of traffic from the STA.

The enhanced trigger frame can include a triggering granularity type field encoded to indicate a type of triggering granularity that is based on a preferred TCID (i.e., preferred TCID based triggering), a preferred TID (i.e., preferred TID based triggering), a preferred TCID and TSID (i.e., preferred TCID and TSID based triggering), a list of preferred TIDs (i.e., list of preferred TIDs based triggering), or preferred one or more SCSIDs (i.e., preferred one or more SCSIDs based triggering). That is, the type triggering granularity is selected from a set of the aforementioned possibilities (represented by respective values).

The enhanced trigger frame also includes a parameter field encoded with particular parameters for the preferred TCID, the preferred TID, the preferred TCID and the preferred TSID, the list of preferred TIDs, and the preferred one or more SCSID to which the station is to respond with specific traffic flows mapped to the particular parameters (e.g., to the particular values for the particular preferred TCID, and so on.

In an embodiment directed to finer granularity triggering based on the preferred TCID, the triggering granularity type field may be omitted from the enhanced trigger frame.

In an embodiment, the first user information field includes the triggering granularity type field and the user parameter field.

In another embodiment, the enhanced trigger frame also includes an additional user information field that includes a second AID field encoded with both the AID of the station and a flag to indicate that the second AID field is present, the triggering granularity type field, and the parameter field. The second AID field may include lower significant bits encoded with the AID of the station and a most significant bit encoded with the flag to indicate the second AID field is present.

At 704, the AP transmits the enhanced trigger frame to trigger the STA to transmit traffic that matches the triggering granularity type and the particular parameters.

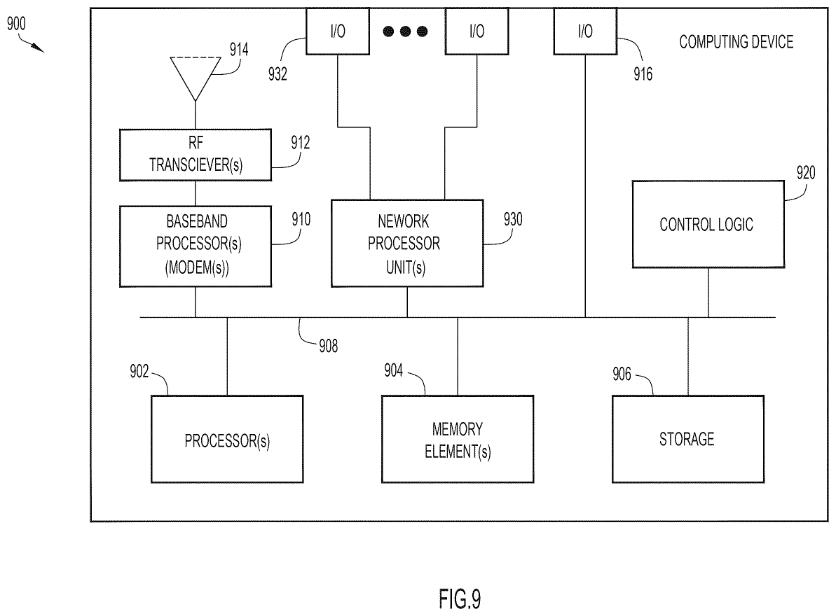

FIG. 8 is a flowchart of an example method 800 performed by an AP in connection with finer granularity triggering of a STA.

At 802, the AP receives from the STA a management frame that indicates STA support (i.e., STA capability) of finer granularity triggering, and STA support for types of triggering granularity (i.e., station-supported types of the triggering granularity) as part of the STA capability indication.

At 804, the AP selects a type of triggering granularity from the types indicated by the STA.

At 806, the AP transmits to the STA an enhanced trigger frame for the finer granularity triggering to include the type of triggering granularity selected at 804 and particular parameters for the type of triggering granularity, as described above.

Referring to FIG. 9, FIG. 9 illustrates a hardware block diagram of a computing device 900 that may perform functions associated with operations discussed herein in connection with the techniques described for embodiments herein. In various embodiments, a computing device or apparatus, such as computing device 900 or any combination of computing devices 900, may be configured as any entity/entities in order to perform operations of the various techniques discussed for embodiments herein, such as any elements, functions, etc. discussed for embodiments herein (e.g., an AP, a STA, etc.).

In at least one embodiment, the computing device 900 may be any apparatus that may include one or more processor(s) 902, one or more memory element(s) 904, storage 906, a bus 908, one or more network processor unit(s) 930 interconnected with one or more network input/output (I/O) interface(s) 932, one or more I/O interface(s) 916, and control logic 920. In various embodiments, instructions associated with logic for computing device 900 can overlap in any manner and are not limited to the specific allocation of instructions and/or operations described herein.

### Computing Device

Computing device 900 may further include at least one baseband processor or modem 910, one or more radio RF transceiver(s) 912 (e.g., any combination of RF receiver(s) and RF transmitter(s)), one or more antenna(s) or antenna array(s) 914 (which may be inclusive of software-defined antenna(s) or antenna array(s) in accordance with embodiments herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa) or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 930 may enable communication between computing device 900 and other systems, entities, etc., via network I/O interface(s) 932 (wired and/or wireless) to facilitate operations discussed for various embodiments described herein. In various embodiments, network processor unit(s) 930 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 932 can be configured as one or more Ethernet port(s), Fibre Channel ports, any other I/O port(s), and/or antenna(s)/antenna array(s) now known or hereafter developed. Thus, the network processor unit(s) 930 and/or network I/O interface(s) 932 may include suitable interfaces for receiving, transmitting, and/or otherwise communicating data and/or information (wired and/or wirelessly) in a network environment.

I/O interface(s) 916 allow for input and output of data and/or information with other entities that may be connected to computing device 900. For example, I/O interface(s) 916 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 912 may perform RF transmission and RF reception of wireless signals via antenna(s)/antenna array(s) 914, and the baseband processor or modem 910 performs baseband modulation and demodulation, etc. associated with such signals to enable wireless communications for computing device 900.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by an access point, including: transmitting, to a station, an enhanced trigger frame to trigger the station to transmit traffic, wherein the enhanced trigger frame includes: a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and a parameter field encoded with particular parameters for the preferred traffic category identifier, the preferred traffic identifier, the preferred traffic stream identifier, or the preferred stream classification service identifier to which the station is to respond with the traffic mapped to the particular parameters.

In some aspects, the techniques described herein relate to a method, wherein: the enhanced trigger frame includes a basic trigger frame or other trigger frame used for triggering uplink traffic from the station.

In some aspects, the techniques described herein relate to a method, wherein: the finer granularity triggering field indicates the finer granularity triggering based on the preferred traffic category identifier; and the particular parameters include a particular preferred traffic category identifier to which the station is to respond with the traffic mapped to the particular preferred traffic category identifier or a higher traffic category identifier.

In some aspects, the techniques described herein relate to a method, wherein: the user information field includes the particular preferred traffic category identifier.

In some aspects, the techniques described herein relate to a method, wherein: the finer granularity triggering is further based on the preferred traffic category identifier and the preferred traffic stream identifier, a list of preferred traffic identifiers, or preferred one or more stream classification service identifiers.

In some aspects, the techniques described herein relate to a method, wherein the enhanced trigger frame further includes: a triggering granularity type field encoded to indicate a type of triggering granularity for the finer granularity triggering that is based on: the preferred traffic category identifier; the preferred traffic identifier; the preferred traffic stream identifier; the preferred traffic category identifier and the preferred traffic stream identifier; the list of preferred traffic identifiers; or the preferred one or more stream classification service identifiers.

In some aspects, the techniques described herein relate to a method, wherein: when the type of the triggering granularity is based on the preferred traffic category identifier, the particular parameters include a particular preferred traffic category identifier to which the station is to respond with the traffic mapped to the particular preferred traffic category identifier or a higher traffic category identifier.

In some aspects, the techniques described herein relate to a method, wherein: when the type of the triggering granularity is based on the preferred traffic identifier, the particular parameters include a particular preferred traffic identifier to which the station is to respond with the traffic mapped to the particular preferred traffic identifier or a higher traffic identifier.

In some aspects, the techniques described herein relate to a method, wherein: when the type of the triggering granularity is based on the preferred traffic stream identifier, the particular parameters include a particular preferred traffic stream identifier to which the station is to respond with the traffic mapped to the particular preferred traffic stream identifier or a higher traffic stream identifier.

In some aspects, the techniques described herein relate to a method, wherein: when the type of the triggering granularity is based on the preferred traffic category identifier and the preferred traffic stream identifier, the particular parameters include a particular preferred traffic identifier and a particular preferred traffic stream identifier to which the station is to respond with the traffic mapped to the particular preferred traffic identifier or a higher traffic identifier and to the particular preferred traffic stream identifier or a higher traffic stream identifier.

In some aspects, the techniques described herein relate to a method, wherein: when the type of the triggering granularity is based on the list of preferred traffic identifiers, the particular parameters include a bitmap that indicates one or more particular preferred traffic identifiers to which the station is to respond with the traffic mapped to any of the one or more particular preferred traffic identifiers.

In some aspects, the techniques described herein relate to a method, wherein: when the type of the triggering granularity is based on the preferred one or more stream classification service identifiers, the particular parameters include particular preferred one or more stream classification service identifiers to which the station is to respond with the traffic mapped to the particular preferred one or more stream classification service identifiers.

In some aspects, the techniques described herein relate to a method, wherein: the user information field includes the triggering granularity type field.

In some aspects, the techniques described herein relate to a method, wherein the enhanced trigger frame further includes: an additional user information field that includes: a second AID field encoded with the AID of the station and a flag to indicate that the additional user information field is a second user information field for the station; and the parameter field.

In some aspects, the techniques described herein relate to a method, wherein: the additional user information field further includes the triggering granularity type field.

In some aspects, the techniques described herein relate to a method, wherein: the second AID field includes lower significant bits encoded with the AID of the station and a most significant bit encoded with the flag.

In some aspects, the techniques described herein relate to a method, further including, by the access point: transmitting a management frame that advertises a finer granularity triggering capability of the access point.

In some aspects, the techniques described herein relate to a method, wherein: the management frame includes one of a beacon, a probe response, an association response frame, or a reassociation response frame.

In some aspects, the techniques described herein relate to a method, further including, by the access point: upon receiving, from the station, a management frame that indicates that the station supports the finer granularity triggering and further indicates a station-supported type of triggering granularity that is supported by the station, selecting a type of the triggering granularity based on the station-supported type of the triggering granularity; and transmitting the enhanced trigger frame using the type.

In some aspects, the techniques described herein relate to a method, further including, by the access point: when additional lower traffic identifiers from best effort access category (AC_BE) or background access category (AC_BK) are mapped to carry flows of higher access categories of voice (AC_VO) or video (AC_VI), then for the finer granularity triggering based on the preferred traffic category identifier, the preferred traffic identifier, the preferred traffic stream identifier, or the preferred traffic category identifier and the preferred traffic stream identifier, the station is allowed to respond with the traffic mapped to the additional lower traffic identifiers.

In some aspects, the techniques described herein relate to a method, further including: the station is allowed to respond with the traffic mapped to the additional lower traffic identifiers if an access category of the traffic corresponds to the access category of the preferred traffic category identifier, the preferred traffic identifier, or the preferred traffic stream identifier or a higher access category.

In some aspects, the techniques described herein relate to an apparatus including: a network interface unit to communicate with a network; and processor of an access point, wherein the processor is coupled to the network interface unit and is configured to perform: causing the access point to transmit, to a station, an enhanced trigger frame to trigger the station to transmit traffic, wherein the enhanced trigger frame includes: a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and a parameter field encoded with particular parameters for the preferred traffic category identifier, the preferred traffic identifier, the preferred traffic stream identifier, or the preferred stream classification service identifier to which the station is to respond with the traffic mapped to the particular parameters.

In some aspects, the techniques described herein relate to an apparatus, wherein: the finer granularity triggering is further based on the preferred traffic category identifier and the preferred traffic stream identifier, a list of preferred traffic identifiers, or preferred one or more stream classification service identifiers.

In some aspects, the techniques described herein relate to an apparatus, wherein the enhanced trigger frame further includes: a triggering granularity type field encoded to indicate a type of triggering granularity for the finer granularity triggering that is based on: the preferred traffic category identifier; the preferred traffic identifier; the preferred traffic stream identifier; the preferred traffic category identifier and the preferred traffic stream identifier; the list of preferred traffic identifiers; or the preferred one or more stream classification service identifiers.

In some aspects, the techniques described herein relate to a non-transitory computer readable medium encoded with instructions that, when executed by a processor of an access point, cause the access point to perform: transmitting, to a station, an enhanced trigger frame to trigger the station to transmit traffic, wherein the enhanced trigger frame includes: a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and a parameter field encoded with particular parameters for the preferred traffic category identifier, the preferred traffic identifier, the preferred traffic stream identifier, or the preferred stream classification service identifier to which the station is to respond with the traffic mapped to the particular parameters.

In some aspects, the techniques described herein relate to a non-transitory computer readable medium, wherein: the finer granularity triggering is further based on the preferred traffic category identifier and the preferred traffic stream identifier, a list of preferred traffic identifiers, or preferred one or more stream classification service identifiers.

In some aspects, the techniques described herein relate to a non-transitory computer readable medium, wherein the enhanced trigger frame further includes: a triggering granularity type field encoded to indicate a type of triggering granularity for the finer granularity triggering that is based on: the preferred traffic category identifier; the preferred traffic identifier; the preferred traffic stream identifier; the preferred traffic category identifier and the preferred traffic stream identifier; the list of preferred traffic identifiers; or the preferred one or more stream classification service identifiers.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed by an access point, comprising:
transmitting, to a station, an enhanced trigger frame to trigger the station to transmit traffic, wherein the enhanced trigger frame includes:
a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and
a parameter field encoded with particular parameters for the preferred traffic category identifier, the preferred traffic identifier, the preferred traffic stream identifier, or the preferred stream classification service identifier to which the station is to respond with the traffic mapped to the particular parameters.

2. The method of claim 1, wherein:
the enhanced trigger frame includes a basic trigger frame or other trigger frame used for triggering uplink traffic from the station.

3. The method of claim 1, wherein:
the finer granularity triggering field indicates the finer granularity triggering based on the preferred traffic category identifier; and
the particular parameters include a particular preferred traffic category identifier to which the station is to respond with the traffic mapped to the particular preferred traffic category identifier or a higher traffic category identifier.

4. The method of claim 3, wherein:
the user information field includes the particular preferred traffic category identifier.

5. The method of claim 1, wherein:
the finer granularity triggering is further based on the preferred traffic category identifier and the preferred traffic stream identifier, a list of preferred traffic identifiers, or preferred one or more stream classification service identifiers.

6. The method of claim 5, wherein the enhanced trigger frame further includes:
a triggering granularity type field encoded to indicate a type of triggering granularity for the finer granularity triggering that is based on:
the preferred traffic category identifier;
the preferred traffic identifier;
the preferred traffic stream identifier;
the preferred traffic category identifier and the preferred traffic stream identifier;
the list of preferred traffic identifiers; or
the preferred one or more stream classification service identifiers.

7. The method of claim 6, wherein:
when the type of the triggering granularity is based on the preferred traffic category identifier, the particular parameters include a particular preferred traffic category identifier to which the station is to respond with the traffic mapped to the particular preferred traffic category identifier or a higher traffic category identifier.

8. The method of claim 6, wherein:
when the type of the triggering granularity is based on the preferred traffic identifier, the particular parameters include a particular preferred traffic identifier to which the station is to respond with the traffic mapped to the particular preferred traffic identifier or a higher traffic identifier.

9. The method of claim 6, wherein:
when the type of the triggering granularity is based on the preferred traffic stream identifier, the particular parameters include a particular preferred traffic stream identifier to which the station is to respond with the traffic mapped to the particular preferred traffic stream identifier or a higher traffic stream identifier.

10. The method of claim 6, wherein:
when the type of the triggering granularity is based on the preferred traffic category identifier and the preferred traffic stream identifier, the particular parameters include a particular preferred traffic identifier and a particular preferred traffic stream identifier to which the station is to respond with the traffic mapped to the particular preferred traffic identifier or a higher traffic identifier and to the particular preferred traffic stream identifier or a higher traffic stream identifier.

11. The method of claim 6, wherein:
when the type of the triggering granularity is based on the list of preferred traffic identifiers, the particular parameters include a bitmap that indicates one or more particular preferred traffic identifiers to which the station is to respond with the traffic mapped to any of the one or more particular preferred traffic identifiers.

12. The method of claim 6, wherein:
when the type of the triggering granularity is based on the preferred one or more stream classification service identifiers, the particular parameters include particular preferred one or more stream classification service identifiers to which the station is to respond with the traffic mapped to the particular preferred one or more stream classification service identifiers.

13. The method of claim 6, wherein:
the user information field includes the triggering granularity type field.

14. The method of claim 13, wherein the enhanced trigger frame further includes:
an additional user information field that includes:
a second AID field encoded with the AID of the station and a flag to indicate that the additional user information field is a second user information field for the station; and
the parameter field.

15. The method of claim 14, wherein:
the additional user information field further includes the triggering granularity type field.

16. The method of claim 14, wherein:
the second AID field includes lower significant bits encoded with the AID of the station and a most significant bit encoded with the flag.

17. The method of claim 1, further comprising, by the access point:
transmitting a management frame that advertises a finer granularity triggering capability of the access point.

18. The method of claim 17, wherein:
the management frame includes one of a beacon, a probe response, an association response frame, or a reassociation response frame.

19. The method of claim 1, further comprising, by the access point:
upon receiving, from the station, a management frame that indicates that the station supports the finer granularity triggering and further indicates a station-supported type of triggering granularity that is supported by the station, selecting a type of the triggering granularity based on the station-supported type of the triggering granularity; and
transmitting the enhanced trigger frame using the type.

20. The method of claim 1, further comprising, by the access point:
when additional lower traffic identifiers from best effort access category (AC_BE) or background access category (AC_BK) are mapped to carry flows of higher access categories of voice (AC_VO) or video (AC_VI), then for the finer granularity triggering based on the preferred traffic category identifier, the preferred traffic identifier, the preferred traffic stream identifier, or the preferred traffic category identifier and the preferred traffic stream identifier, the station is allowed to respond with the traffic mapped to the additional lower traffic identifiers.

21. The method of claim 20, further comprising:
the station is allowed to respond with the traffic mapped to the additional lower traffic identifiers if an access category of the traffic corresponds to the access category of the preferred traffic category identifier, the preferred traffic identifier, or the preferred traffic stream identifier or a higher access category.

22. An apparatus comprising:
a network interface unit to communicate with a network; and
processor of an access point, wherein the processor is coupled to the network interface unit and is configured to perform:
causing the access point to transmit, to a station, an enhanced trigger frame to trigger the station to transmit traffic, wherein the enhanced trigger frame includes:
a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and
a parameter field encoded with particular parameters for the preferred traffic category identifier, the preferred traffic identifier, the preferred traffic stream identifier, or the preferred stream classification service identifier to which the station is to respond with the traffic mapped to the particular parameters.

23. The apparatus of claim 22, wherein:
the finer granularity triggering is further based on the preferred traffic category identifier and the preferred traffic stream identifier, a list of preferred traffic identifiers, or preferred one or more stream classification service identifiers.

24. The apparatus of claim 23, wherein the enhanced trigger frame further includes:
a triggering granularity type field encoded to indicate a type of triggering granularity for the finer granularity triggering that is based on:
the preferred traffic category identifier;
the preferred traffic identifier;
the preferred traffic stream identifier;
the preferred traffic category identifier and the preferred traffic stream identifier;
the list of preferred traffic identifiers; or
the preferred one or more stream classification service identifiers.

25. A non-transitory computer readable medium encoded with instructions that, when executed by a processor of an access point, cause the access point to perform:
transmitting, to a station, an enhanced trigger frame to trigger the station to transmit traffic, wherein the enhanced trigger frame includes:
a user information field having an association identifier (AID) field encoded with an AID of the station, and a finer granularity triggering field indicating finer granularity triggering based on a preferred traffic category identifier, a preferred traffic identifier, a preferred traffic stream identifier, or a preferred stream classification service identifier; and
a parameter field encoded with particular parameters for the preferred traffic category identifier, the preferred traffic identifier, the preferred traffic stream identifier, or the preferred stream classification service identifier to which the station is to respond with the traffic mapped to the particular parameters.

26. The non-transitory computer readable medium of claim 25, wherein:
the finer granularity triggering is further based on the preferred traffic category identifier and the preferred traffic stream identifier, a list of preferred traffic identifiers, or preferred one or more stream classification service identifiers.

27. The non-transitory computer readable medium of claim 26, wherein the enhanced trigger frame further includes:
a triggering granularity type field encoded to indicate a type of triggering granularity for the finer granularity triggering that is based on:
the preferred traffic category identifier;
the preferred traffic identifier;
the preferred traffic stream identifier;
the preferred traffic category identifier and the preferred traffic stream identifier;
the list of preferred traffic identifiers; or
the preferred one or more stream classification service identifiers.
